(19) United States
(12) Patent Application Publication
(10) Pub. No.: US 2016/0297329 A1
(43) Pub. Date: Oct. 13, 2016

(54) VEHICLE SEAT WITH A LEAD-THROUGH FOR A TRACTION MEANS

(71) Applicant: Brose Fahrzeugteile GmbH & Co. Kommanditgesellschaft, Coburg, Coburg (DE)

(72) Inventor: Lars ELLERMANN, Coburg (DE)

(73) Assignee: Brose Fahrzeugteile GmbH & Co. Kommanditgesellschaft, Coburg, Coburg (DE)

(21) Appl. No.: 15/034,287

(22) PCT Filed: Oct. 30, 2014
(86) PCT No.: PCT/EP2014/073278

§ 371 Date: May 4, 2016

(30) Foreign Application Priority Data
Nov. 6, 2013 (DE) 10 2013 222 537.7

(51) Int. Cl. B60N 2/22; B60N 2/20

(52) U.S. Cl. CPC B60N 2/22; B60N 2/20

(57) ABSTRACT

It is provided a vehicle seat with at least one first seat component, such as a backrest, which is pivotally mounted relative to another, second seat component of the vehicle seat, and with a flexible traction means for an actuating mechanism at the vehicle seat. Further a bearing element is provided, which defines a physical pivot axis for the first seat component and defines a channel through which a portion of the traction means extends from the first seat component to the second seat component. Alternatively, a fastening element which is arranged close to the pivot axis can form the channel for the traction means.

### CROSS-REFERENCE TO A RELATED APPLICATION

This application is a National Phase Patent Application of International Patent Application Number PCT/EP2014/073278, filed on Oct. 30, 2014, which claims priority of German Patent Application Number 10 2013 222 537.7, filed on Nov. 6, 2013.

### BACKGROUND

The present invention relates to a vehicle seat.

In a generic vehicle seat at least one first seat component is pivotally mounted relative to another, second seat component of the vehicle seat and furthermore a flexible traction means for an actuating mechanism is provided at the vehicle seat. The pivotally mounted first seat component for example is a backrest of the vehicle seat which is pivotable relative to a seat base of the vehicle seat and possibly can be folded forwards onto a seating surface. The flexible traction means, for example a Bowden cable, can be part of an actuating mechanism which for actuating a latch at the vehicle seat and/or for triggering and/or maintaining an adjusting movement of an adjustable part is provided at the vehicle seat. A Bowden cable for example can connect an actuating element at the backrest with a lock at the seat base, so that by actuating the actuating element a latch can be released and a backrest can be folded forwards. Furthermore, it is known for example to couple a flexible traction means with an adjustably mounted headrest as adjustable part, in order to trigger an automatic retraction of the headrest when a backrest is folded forwards.

As in such vehicle seat a flexible traction means can extend between two seat components pivotally mounted relative to each other and preferably shall connect an element arranged on the first seat component with a second element arranged on the second seat component, a relative movement of the two seat components must be compensated by the flexible traction means. In a Bowden cable, the consequence for example is that the Bowden sheath also must be designed flexible at least in a certain region and the entire Bowden cable is designed longer. This, however, can involve undesired (rattling) noises, in particular during the ride, as the Bowden cable cannot be mounted as firmly as desired. In addition, a longer Bowden cable involves an additional weight.

In a Bowden cable installed within a backrest of the vehicle seat, which extends down to a seat base of the vehicle seat, the additional difficulty also exists in practice that a padding and an upholstery of the backrest cannot be closed completely, as the Bowden cable must be guided out of the interior of the backrest via a separate opening. This possibly is disadvantageous in particular with regard to the fabrication of the upholstery and to the design of the vehicle seat.

### SUMMARY

Proceeding therefrom it is an object underlying the present invention to provide a vehicle seat in which the installation of a flexible traction means between seat components of the vehicle seat pivotally mounted relative to each other is improved.

This object is solved with a vehicle seat as described herein.

According to the invention a bearing element is provided on the vehicle seat, which forms a physical pivot axis for the first, pivotally mounted seat component of the vehicle seat and defines a channel through which a portion of a flexible traction means at the vehicle seat extends from the first seat component to a second seat component, relative to which the first seat component is pivotally mounted. Another solution according to the invention provides to utilize a fastening element arranged close to the pivot axis of the first seat component for the lead-through of the traction means and to form a channel for the traction means in or at the same.

The flexible traction means thereby at least partly extends on or in a bearing element, which on the second seat component forms a or the only physical pivot axis for the first seat component, or is arranged on or in an anyway provided fastening element which is arranged at a smaller distance to the pivot axis.

The traction means thus for example can extend along the channel defined by the bearing element preferably along the pivot axis. In this way, it is achieved that when pivoting the first seat component relative to the second seat component the flexible traction means need not compensate a relative movement, whereby the installation of the traction means at the vehicle seat is facilitated. In the case of a lead-through via a fastening element, such as a screw or a bolt, in the vicinity of the pivot axis, a compensation of the relative movement can at least be limited to a small extent.

The distance of a fastening element with a channel for the traction means to the pivot axis of a backrest for example is chosen so small that a frame-side end of the traction means, which is guided to the outside via the channel, no longer must protrude beyond the seat width when the backrest is in an upright position. In solutions according to the invention it frequently was not the case that at a frame-side end of a traction means for an actuating mechanism, by means of which a latch of the backrest is released and folding forwards of the backrest is permitted, a larger loop protruding laterally beyond the seat width had to be provided, so that the traction means can compensate the movement of the backrest relative to the seat base when the backrest is folded forwards. With a solution according to the invention this can be avoided with a fastening element close to the pivot axis, which additionally is provided with a channel for the traction means, or with a bearing element with channel.

A fastening element arranged close to the pivot axis for example is understood to be a fastening element which maximally is away from the pivot axis by a certain fraction of the length of a part of the traction means protruding out of the fastening element. When the traction means is divided into two parts by the fastening element, which parts protrude out of the fastening element on different sides, for example into a first part which extends from an actuating element on a backrest to the fastening element, and a second part which extends from a frame-mounted actuating element or a frame-mounted fixation to the fastening element.

A possible distance of the fastening element arranged close to the pivot axis then can correspond to a fraction of the length of the shorter part and preferably is dependent on a maximum admissible swivel angle of the first seat component relative to the second seat component. An admissible maximum distance between the pivot axis and the fastening element, through whose channel the traction means is guided, hence depends on the maximum permitted rotation of the first seat component relative to the second seat component. The smaller the maximum permitted rotation and hence the maximum admissible swivel angle, the larger the admissible distance of the fastening element can be in fractions of the length of the shorter part of the traction means.

For example, a connection between a) a possible distance or offset of the fastening element to the pivot axis, expressed as fraction of the length of the shorter part of the traction means, and b) the maximum permitted rotation of the first seat component to the second seat component can be given by the following formula:

y=x²−2x+1,

wherein x corresponds to the maximum permitted swivel angle expressed in fractions of 360° and y corresponds to the maximum distance or offset to the pivot axis expressed in fractions of the length of the shorter part of the traction means. With the formula indicated above, for example at a value of x=0.5, which corresponds to a maximum possible swivel angle of 180°, y=0.25, so that a possible maximum distance d of the fastening element from the pivot axis is allowed to amount to a quarter of the length of the shorter traction means part (d=0.25*[length of the shorter traction means part]). Analogously, for a maximum swivel angle of 36° (x= 1/10), 45° (x=⅛), 60° (x=⅙) or 90° (x=¼), the distance should be maximally 0.81 (y= 81/100), about 0.77 (y= 49/64), about 0.7 (y= 25/36) or about 0.56 (y= 9/16) times the length of the shorter traction means part.

As already mentioned above, the flexible traction means for example can be provided for an actuating mechanism for actuating a latch and/or for triggering and/or maintaining an adjusting movement of an adjustable part at the vehicle seat.

The flexible traction means thus can connect an actuating element, for example an actuating handle, at the pivotally mounted seat component with a further actuating element at the other seat component, in order to release a latch of the first seat component and to permit pivoting thereof relative to the second seat component. The flexible traction means thus for example can be part of a so-called easy-entry mechanism in which a first seat component in the form of a backrest of the vehicle seat is pivotable relative to a seat base and can be folded forwards onto a seating surface of the vehicle seat to facilitate the entry. Via an actuating mechanism with a flexible traction means, however, a latch of a forward-folding backrest for a rear seat row can of course also be releasable.

Furthermore, the flexible traction means can be part of an actuating mechanism by means of which during forward-folding of a backrest an automatic retraction of a headrest of the vehicle seat is controlled. The flexible traction means here is coupled with the headrest as adjustable part or with an associated adjustable part of an adjusting device for the headrest and with a seat-frame-mounted element, so that during forward-folding of the backrest via the flexible traction means the headrest automatically is lowered at the backrest. Via a flexible traction means an adjusting movement of a headrest thus can also be controlled, which headrest is arranged on a pivotally mounted backrest as first seat component.

The channel of the bearing element defining a physical pivot axis or of a fastening element preferably is designed closed in circumferential direction, so that the channel extends completely within the bearing element in the manner of a bore or a rim hole. Of course, however, a design as partly, e.g. unilaterally open channel also is conceivable

In a preferred design variant the traction means extends through the channel from a seat inner side to a side outer side. The different seat sides are defined with a view to a front side of the vehicle seat, i.e. consequently with a view to a seating surface of the vehicle seat or a surface of the backrest of the vehicle seat, on which a seat user is supported. The traction means thus for example extends through at least one right or left seat side part, e.g. a part of a seat bolster and/or a backrest fitting, through the channel of the bearing element or the fastening element, so that the traction means is guided from an interior of the vehicle seat to the outside.

Alternatively, however, it is also conceivable that the flexible traction means on one and the same seat side is guided into the bearing element or fastening element and out of the bearing element or fastening element. Thus, a bearing element for example can define a channel which has a channel end running radially to the outside relative to the pivot axis and in this way for example a flexible traction means is guided from the interior of a backrest via the channel first along a pivot axis of the backrest onto an inside of a backrest fitting, but not up to the outside of the backrest fitting, in order to connect the traction means with an element on the inside of a frame-mounted fitting or frame-mounted seat bolster part, e.g. an element of a latch. Consequently, the flexible traction means in one design variant also can extend through the channel only from a backrest inner side to a backrest outer side of a pivotable backrest of the vehicle seat, wherein the different backrest sides are defined by a longitudinally extending backrest side part of the backrest frame, such as e.g. a lateral backrest bar.

Correspondingly, the bearing element in one exemplary embodiment can be provided for the provision of a physical pivot axis for a pivotally mounted first seat component, but via the bearing element or at least its channel no connection between a seat inner side and a seat outer side can be made possible.

In any case, however, it is achieved by the formation of a channel for a flexible traction means at or in a bearing element, which at the same time forms a pivot axis for the respective first seat component, or at an anyway provided fastening element, that for guiding the flexible traction means from the pivotally mounted first seat component to the other, second seat component, relative to which the first seat component is pivotable, no additional holes, apertures or bores must be provided at the structure of the vehicle seat. With the bearing element or the fastening element an anyway provided component or an anyway provided region rather is utilized for the lead-through of the flexible traction means and provided with an additional function.

In one exemplary embodiment, the bearing element or the fastening element is mounted to the second seat component as separate component. For example, the bearing element or the fastening element here is designed with a hollow bolt in which the traction means extends along the longitudinal bolt axis coinciding with the pivot axis. With such hollow bolt, for example, a pivotable bearing for a backrest then is defined on a seat base. Such hollow bolt also can be part of a backrest fitting for the backrest. In one design variant the fastening element comprises a hollow screw which includes an internal channel for the lead-through of the traction means.

As already explained above, the traction means can be designed as Bowden cable with a core which at least partly is guided in a Bowden sheath and is enclosed by the same.

In one design variant the traction means includes a Bowden and piece in which the core is shiftably mounted, in order to transmit an actuating force. This Bowden end piece then is fixed at the bearing element or the fastening element, in order to prevent that the core can easily be pulled out of the bearing element or fastening element. Preferably, the Bowden end piece therefor is locked into place at the bearing element or the fastening element, for example via at least one elastic latching hook or clip provided at the Bowden end piece, which with a proper assembly of the vehicle seat snaps into place at the bearing element or the fastening element. Such Bowden end piece hence can define a pull-out protection with which it is prevented that the traction means once installed properly through the channel of the bearing element or fastening element can be pulled out of the channel inadvertently.

Preferably, a Bowden end piece is formed of a plastic material.

In one design variant a portion of the core of a Bowden cable without Bowden sheath can extend through the channel of the bearing element or the fastening element. Outside the channel, a Bowden sheath can support on the bearing element or the fastening element.

In one design alternative it is provided that a portion of the core of the Bowden cable together with a Bowden sheath or a portion of the Bowden sheath extends through the channel of the bearing element or the fastening element. In this case, during assembly a part of the complete Bowden cable with Bowden sheath is pulled through the channel of the bearing element or the fastening element.

In one design variant the channel for the lead-through of the traction means is provided on a fastening element of the vehicle seat, by means of which an adapter of a backrest fitting is fixed. For example, a screw or a bolt is utilized as fastening element for the lead-through of the traction means, which screw or bolt is located in the vicinity of the pivot axis of the backrest and by means of which a frame-side adapter—usually in the form of an adapter plate—is fixed at a component of the seat base.

### BRIEF DESCRIPTION OF THE DRAWINGS

Further advantages and features of the present invention will become apparent from the following description of exemplary embodiments with reference to the Figures.

FIG. 1 shows a perspective view of a design variant of a vehicle seat according to the invention with two schematically illustrated flexible traction means, each in the form of a Bowden cable.

FIGS. 2A-2B partially show side views of the vehicle seat of FIG. 1 with erected and forward-folded backrest.

FIG. 3 shows a sectional detail view of a bearing element in the form of a hollow bearing bolt for guiding the core of a Bowden cable according to FIG. 1 from the interior of the backrest along its pivot axis to a backrest outer side or seat outer side on a seat base on which the backrest is pivotally mounted via the bearing bolt.

### DETAILED DESCRIPTION

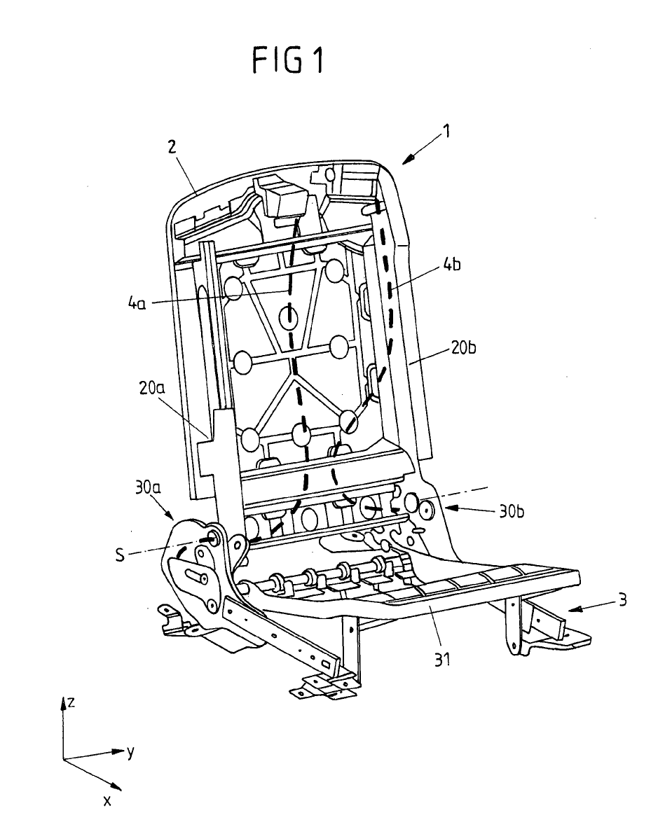

FIG. 1 in a perspective view and schematically shows a design variant for a vehicle seat 1 according to the invention, in which a backrest 2 is pivotally mounted about a pivot axis S and in particular mounted so as to be folded forwards on a seat base 3. The backrest 2 can be adjusted in its inclination relative to a seat part 31 of the seat base 3 about the pivot axis S and can be folded forwards onto the seat part 31 about the pivot axis S. so that in the position of the backrest 2 folded forwards a storage space of a vehicle is increased and/or an entry of a vehicle occupant past the vehicle seat 1 is facilitated.

The seat part 31 here is articulated to the seat base 3 in a manner known per se, so that the seat part 31 can be lowered when the backrest 2 is folded forwards, in order to be able to fold the vehicle seat 1 as compact as possible and to lower a front of the seat part 31 or a seat pan defined therewith.

The vehicle seat 1 furthermore includes two backrest or seat fittings 30a and 30b opposing each other along the pivot axis 5, via which the backrest 2 is pivotally mounted. Backrest side parts 20a and 20b of the backrest 2 likewise opposing each other, which form parts of a backrest frame of the backrest 2, are mounted on the seat base 3 via the seat fittings 30a and 30b. To arrest the backrest 2 in a desired inclined position relative to the seat part 31 the seat fittings 30a and 30b for example can be formed as detent fittings in a manner known per se. Furthermore, a locking device (not shown) is provided, in order to arrest the backrest 2 in the illustrated upright position and to be able to fold the same forwards onto the seat part 31 when locking via the locking device is released.

Furthermore, a non-illustrated headrest of the vehicle seat 1 can be adjustable automatically via a likewise non-illustrated adjusting device during a tilt adjustment of the backrest 2 and/or during forward-folding of the backrest 2 onto the seat part 31. It is known for example to automatically retract a headrest of a vehicle seat 1, i.e. to lower the same in direction of a lower end of the backrest 2, when the backrest 2 is folded forwards onto the seat part 31, so that the backrest 2 folded forwards together with the headrest requires as little space as possible.

Both for releasing a latch, which arrests the backrest 2 in a position relative to the seat base 3 and the seat part 31, and for mechanically coupling the headrest with a component of an adjusting device for retracting the headrest it is known to provide flexible traction means, for example in the form of Bowden cables 4a and 4b, on a vehicle seat 1. The Bowden cables 4a and 4b each extend along the backrest 2—preferably along or in its backrest frame—to the seat base 3. For example, a first Bowden cable 4a as part of an actuating mechanism connects the headrest of the vehicle seat 1 with a component of the adjusting device, which is arranged on the seat base 3. A second Bowden cable 4b as part of an actuating mechanism for a backrest latch connects an actuating element, for example in the form of an actuating handle, at the backrest 2 with another actuating element of the latch at the seat base 3.

In particular in such Bowden cables 4a and 4b, which are arranged on a first pivotally mounted seat component, here the backrest 2, and shall extend to a second seat component, here the seat base 3, on which the first seat component is pivotally mounted, the difficulty now exists however that the respective Bowden cable 4a or 4b must compensate a relative movement of the two seat components 2, 3. For this purpose, the Bowden cable 4a, 4b must have an additional flexibility and length, whereby possibly undesired noises are produced in driving operation, as the Bowden cable 4a, 4b cannot be mounted as firmly as desired. In addition, a longer Bowden cable 4a or 4b also has an increased weight. Moreover, in the present case the upholstery of a backrest 2 cannot be designed completely closed, as the Bowden cables 4a and 4b must be guided out of the padded and upholstered backrest 2.

According to the invention, at least one fastening element such as a screw or a bolt for fixing a seat fitting 30a or 30b or a bearing element now is provided on the vehicle seat 1, which forms the physical pivot axis S for the backrest 2, wherein the fastening element or the bearing element defines a channel through which a portion of a Bowden cable 4a or 4b extends from the backrest 2 to the seat base 3, so that the respective Bowden cable 4a or 4b extends through this channel from a seat inner side to a (right or left) seat outer side or at least from a backrest inner side to a backrest outer side.

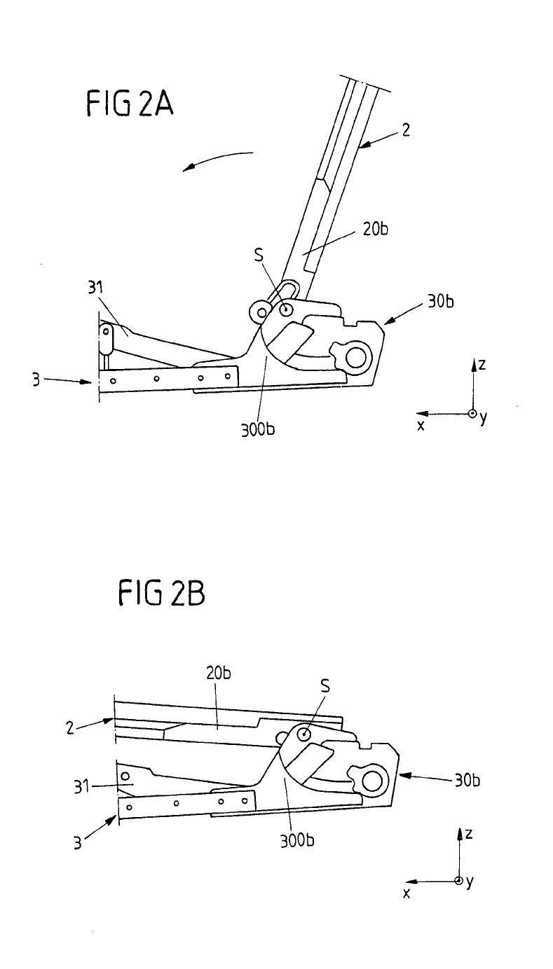

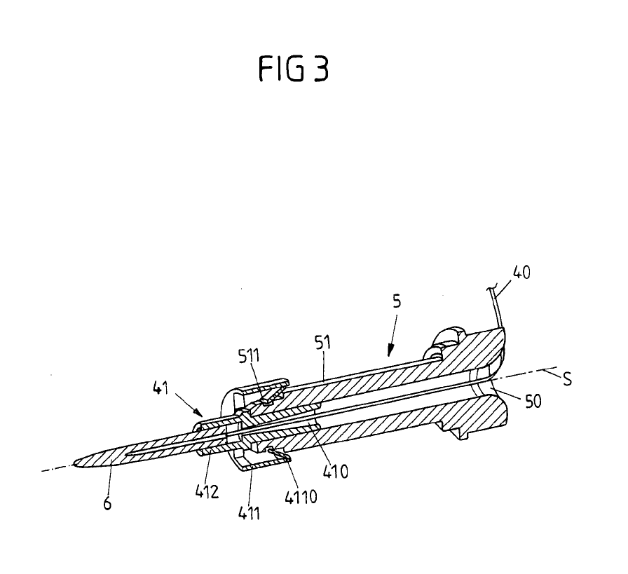

Such bearing element here is formed by a hollow bearing bolt 5 which in FIG. 3 is shown in a sectional view on an enlarged scale. On a circularly cylindrical portion of this bearing bolt 5 one of the backrest side parts 20a or 20b of the backrest is mounted, so that the bearing bolt 5 (also) defines the pivot axis S. As is shown in detail in FIGS. 2A and 2B, the backrest 2 can be folded forwards onto the seat part 31 about this pivot axis S. The bearing bolt 5 for example can be mounted as separate component in a lateral seat bolster part 300b of the seat base 3.

The bearing bolt 5 centrally includes a continuous and completely closed circularly cylindrical channel 50, through which a core 40 of a Bowden cable 4a or 4b is guided. The core 40 of the Bowden cable 4a or 4b thus extends within the channel 50 preferably substantially parallel to or even along the pivot axis S of the backrest 2.

FIG. 3 shows a bearing bolt 5 for the Bowden cable 4b, which as part of an actuating mechanism couples an actuating element at the back of the backrest 2 (not shown) with a locking device which prevents the backrest 2 from folding forwards and can be released by actuating the actuating cable 4b for forward-folding of the backrest 2. In the present case, an end of the core 40 therefore opens into an actuating element designed as locking or actuating pin 6, via which a latch can be released by actuating the actuating cable 4b. In a non-actuated state of the Bowden cable 4b, the actuating pin 6 here engages into a non-illustrated latch opening at the seat base 3 and thereby secures the backrest 2 against forward-folding in direction of the seat part 3. To release the latch, the actuating pin 6 can be pulled out of the latch opening by means of the Bowden cable 4b and thereafter the backrest 2 can be folded about the pivot axis S.

For this purpose, the actuating in 6 here is longitudinally shiftably mounted in a sleeve portion 412. This sleeve portion 412 is formed by a Bowden and piece 41 which is attached to an end of the bearing bolt 5 associated to the seat base 3. The Bowden end piece 41 forms an additional longitudinally extending guide portion with a guide channel 410 for the core 40 and with its guide portion protrudes into the channel 50 of the bearing bolt 5. At the end of the bearing bolt 5 associated to the seat base 3, the Bowden end piece 41 is fixed at the bearing bolt 5 via an additional connecting portion 411.

The connection of the Bowden end piece 41 with the bearing bolt 5 here is effected via a latching connection. At least one elastically designed latching clip or hook 4110 engages behind the end of the bearing bolt 5, over which the circularly cylindrical connecting portion 411 is put like a lid, and engages into a latching groove or notch of a detent portion 511 of the bearing bolt 5. The Bowden end piece 41 thereby can be pushed onto the bearing bolt 5 along the longitudinal bolt axis of the bearing bolt 5 and automatically locks into place with the same, when the connecting and piece 41 is positioned properly. Via the latching hook 4110 of the Bowden end piece 41 the Bowden cable 4b than is secured against inadvertent pulling out of the bearing bolt 5 and at the same time the actuating pin 6 is shiftably mounted on the bearing bolt 5 in the desired way. The latching hook 4110 here acts as a kind of barb, in order to secure the Bowden end piece 41 at the end of the bearing bolt 5.

The Bowden end piece 41 preferably is made of a plastic material. The bearing bolt 5 in turn preferably is made of a metallic material and is designed sufficiently stiff, in order to pivotally mount a side of the backrest 2 on its shell surface 51.

Via the continuous channel 50 extending along the pivot axis S of the backrest 2 in the rigid bearing bolt 5 an effective lead-through here is provided for the flexible Bowden cable 4b (or also 4a), in particular for its core 40, from the backrest 2 to the seat base 3 such that the Bowden cable 4b (4a) need not compensate a relative movement. In this way, the respective Bowden cable 4a or 4b can be installed in an optimized way and in particular be secured better within the backrest 2. With the lead-through via the bearing bolt 5 no additional bore or additional hole is necessary at the structure of the vehicle seat 1, in particular for example at the seat fitting 30a or 30b or the seat bolster part 300b, in order to guide the Bowden cable 4a or 4b to the seat base 3. Rather, with the bearing bolt 5 a component anyway necessary for the support of the backrest 2 can also be utilized for the lead-through of a Bowden cable 4a or 4b.

Deviating from the representation according to FIG. 3 it is of course possible to not only guide the core 40 of a Bowden cable 4a or 4b through the channel 50 of a bearing bolt 5, wherein in this case a non-illustrated Bowden sheath also might support on the bearing bolt 5 from outside. In one design variant it rather is also possible that a core 40 of the Bowden cable 4a or 4b together with a portion of a Bowden sheath is introduced into the channel 50.

Furthermore, instead of a separate hollow bearing bolt 5 an integrally molded sleeve portion can also be provided on a component of the seat base, for example on the seat bolster part 300b, which (also) defines the physical pivot axis S and forms a channel 50 for the lead-through of the Bowden cable 4a or 4b.

In a design variant not shown here in detail, the channel for the lead-through of a Bowden cable 4a or 4b is formed on a fastening element of the vehicle seat 1, by means of which an adapter plate of the seat fitting 30a or 30b is fixed and which thus anyway must be provided on the vehicle seat 1 like the bearing bolt 5. For example, a (hollow) screw or a (hollow) bolt is utilized as fastening element for the lead-through of the Bowden cable 4a or 4b, which screw or bolt is located in the vicinity of the pivot axis S of the backrest 2 and by means of which the adapter plate is fixed at a component of the seat base 3, such as at the seat bolster part 300b.

1-11. (canceled)

12. A vehicle seat with at least one first seat component which is pivotally mounted relative to another, second seat component of the vehicle seat about a pivot axis, and a flexible traction means for an actuating mechanism at the vehicle seat, wherein
a bearing element, which forms a physical pivot axis for the first seat component, or a fastening element utilized for fixing a component of the vehicle seat is provided close to the pivot axis, and
the bearing element or the fastening element defines a channel through which a portion of the traction means extends from the first seat component to the second seat component.

13. The vehicle seat according to claim 12, wherein the traction means extends through the channel from a seat inner side to a seat outer side.

14. The vehicle seat according to claim 12, wherein the traction means connects a first element arranged on the first seat component with a second element arranged on the second seat component.

15. The vehicle seat according to claim 12, wherein the first seat component is formed by a backrest of the vehicle seat and the second seat component is formed by a seat base of the vehicle seat.

16. The vehicle seat according to claim 12, wherein the bearing element or the fastening element is mounted to the second seat component as separate component.

17. The vehicle seat according to claim 16, wherein the bearing element or the fastening element comprises a hollow bolt or a hollow screw.

18. The vehicle seat according to claim 12, wherein the traction means is designed as Bowden cable with a core and includes a Bowden end piece in which the core is shiftably mounted and which is fixed at the bearing element or the fastening element.

19. The vehicle seat according to claim 18, wherein the Bowden end piece is locked into place at the bearing element or the fastening element.

20. The vehicle seat according to claim 12, wherein the traction means is designed as Bowden cable with a core which is at least partly guided in a Bowden sheath, and only a portion of the core without Bowden sheath extends through the channel of the bearing element or the fastening element.

21. The vehicle seat according to claim 12, wherein the traction means is designed as Bowden cable with a core which is at least partly guided in a Bowden sheath, and a portion of the core with Bowden sheath extends through the channel of the bearing element or the fastening element.

22. The vehicle seat according to claim 12, wherein the fastening element is provided for fixing an adapter of a backrest fitting.
